(19) United States
(12) Patent Application Publication
(10) Pub. No.: US 2004/0166361 A1
(43) Pub. Date: Aug. 26, 2004

(54) Surface coating of black platinum

(76) Inventors: Michael Oechsle, Salach (DE); Ralf Karch, Kleinostheim (DE); Bernd Kayser, Aschaffenburg (DE)

Correspondence Address: KALOW & SPRINGUT LLP, 488 MADISON AVENUE, 19TH FLOOR, NEW YORK, NY, 10022, US

(21) Appl. No.: 10/477,842

(22) PCT Filed: May 21, 2002
(86) PCT No.: PCT/EP02/05568

(30) Foreign Application Priority Data
May 18, 2001 (DE) 101 24 426.6

(51) Int. Cl. B05D 3/02; C22C 5/04; B32B 15/01

(52) U.S. Cl. 428/670; 427/229; 427/383.1; 420/466

(57) ABSTRACT

The present invention provides a surface coating of platinum in which the coating is formed from platinum in a black modification. This can be obtained by applying an organic platinum complex compound with platinum in the oxidation state 0 that decomposes thermally at temperatures below 200° C., or a coating composition which consists substantially of such a platinum complex compound, to the surface of a substrate and then thermally decomposing the platinum complex compound. The surface coatings can be used in many ways, for example as protective layers against mechanical and/or chemical and/or thermal effects, as antiadhesion layers, as antireflective layers or as catalytically active layers.

The invention provides a surface coating of platinum in which the coating is formed from a black modification of platinum.

The noble metal platinum (as also its alloys) is a material that is used, due to a number of very advantageous material properties, not only in the decorative field (e.g., as an ornamental metal for jewellery), but also to a large extent as an industrial material. In addition to the aesthetically pleasing silvery shine of platinum metal, which is very important in the decorative or jewellery areas, platinum is also characterised by a high melting point and high strength, and thus by a particular resistance to mechanical and/or chemical and/or thermal effects. In addition, the element platinum has special catalytic properties that are used in chemistry in the widest sense, for example in a number of synthetic reactions or for catalysed decomposition or combustion reactions such as, for example, for the treatment of exhaust gases (e.g. in car exhaust catalysts) or for producing electric power in fuel cells.

A typical area of use for platinum as a structural material is in the glass industry. There, in particular in plant for melting and hot-forming special glass, components made of platinum are used. Platinum and PGM (platinum group metals) materials are characterised by high resistance to thermal and corrosive effects due to their high melting points and, furthermore, by high mechanical strength and resistance to abrasion and are therefore particularly suitable for preparing structural parts in plants or parts of plants that come into contact with molten glass.

With many of these components, or in other industrial applications that require the use of platinum as a material, it may be sufficient to apply the platinum as a layer, optionally also as a thin layer, to a substrate material.

Platinum coatings can be applied to substrate surfaces in a number of different ways.

Plating with platinum sheeting or thin platinum foils is a common procedure. Other possibilities are application welding, possibly with the aid of lasers or microplasma, or electrodeposition, primarily from platinum fused salt electrolytes.

Thin platinum functional layers with thicknesses down to the μm range can be produced by thermal spray processes such as flame spraying, high-speed flame spraying, electric arc spraying or plasma spraying.

The industrial properties of platinum coatings produced in this way naturally vary with the method used to produce the coating, the structure of the layer, the thickness of the layer, the nature of the surface of the substrate and the coating and any post-treatments involved.

A common feature of all of the coating methods mentioned is that they provide platinum layers with typical metallic characteristics, that is they are metallic grey to very shiny silver-white, depending on the nature of the surface (e.g., roughness, porosity).

All of the known methods for producing platinum layers are costly in terms of work and time and/or require technically complicated, and thus expensive, equipment and do not enable, or do not readily enable, the post-coating or repair of defective layers.

The production of platinum layers by applying platinum in the form of chemical compounds to substrate surfaces and then decomposing the compounds into elemental metallic platinum has not been disclosed.

EP 0 987 777 A1 discloses the preparation of a catalyst layer for fuel cells, in particular polymer electrolyte membrane fuel cells. This is obtained by coating a substrate material with an “ink,” which is a dispersion of electrically conductive carbon particles in a solution of a proton-conducting polymer that also contains an organic platinum complex compound. By drying at moderate temperature, the platinum complex compound is decomposed into catalytically active platinum particles finely distributed in the layer of polymer and carbon. The organic platinum complex compounds used here, such as in particular the complex of platinum with 1,3-divinyl-1,1,3,3-tetramethyldisiloxane (“Pt-VTS”), contain platinum in the oxidation state 0 and decompose thermally at temperatures below 200° C.

In connection with the aforementioned development, it was discovered, by chance, that by coating and thermally decomposing organic platinum complex compounds, which contain platinum in the oxidation state 0 and which can be thermally decomposed at temperatures below 200° C., platinum coatings are obtained on substrate surfaces which have surprising, unusual and, for a number of different industrial applications, extremely advantageous properties.

The present invention provides a surface coating of platinum in which the coating is formed from a black modification of platinum.

The most striking property of the surface coating of platinum obtained according to the present invention is that it does not have the typical metallic appearance that would normally be expected, that is a metallic grey to very shiny silver-white appearance, but that it is black, even after annealing at up to 1450° C. Accordingly, in a coating of this type, it is formed from a black modification of platinum.

The present invention also provides a process for preparing these types of black platinum coatings, coating compositions for these and various practical applications of these types of layers.

In one embodiment, the present invention provides a surface coating, comprising a coating that is formed from a black modification of platinum and silicon and/or a silicon compound. The silicon compound can comprise platinum silicide and/or silica and/or silicon carbide.

In another embodiment, the present invention provides a process for preparing a surface coating of platinum in a black modification, comprising an organic platinum complex compound with platinum in the oxidation state 0 and that decomposes thermally at temperatures below 200° C. that is applied to the surface of a substrate compound and subsequently thermally decomposed.

The surface coatings according to the invention made of platinum in a black modification are obtainable by applying an organic platinum complex compound with the platinum in oxidation state 0, which decomposes thermally at temperatures below 200° C. to form fine dispersoid platinum particles, or a coating composition that consists substantially of such a platinum complex compound, to the surface of a substrate and then thermally decomposing the platinum complex compound.

Substrates that can be used are all materials and items made of materials that readily withstand a temperature of 200° C. without suffering damage. Typical substrate materials are, for example, glass, ceramics, metal, plastics (with suitable thermal stability), composite materials. There is no special requirement placed on the nature of the surface of the substrate; it may be flat and smooth, structured, rough or even porous.

Tests on these new types of black platinum coatings have shown that they are formed-of fine dispersoid platinum particles. The fine dispersoid platinum particles in the layer can be arranged in contact with each other or be isolated.

The surface coatings according to the invention made of platinum in a black modification can readily be produced in a thickness of 1 nm to 10 μm. The concentration per unit of area of platinum in the layer is preferably from 0.01 to 100 g/m².

The particular type of layer production and the peculiarities of the layer structure resulting therefrom are obviously responsible for the black appearance and the technical properties of the platinum coating according to the invention.

The process to prepare a surface coating of platinum in a black modification is performed in such a way that an organic platinum complex compound with platinum in the oxidation state 0 that decomposes thermally at temperatures below 200° C. with the formation of fine dispersoid platinum particles, or a coating composition that consists substantially of such a platinum complex compound, is applied to the surface of a substrate and then the platinum complex compound is thermally decomposed.

These types of compounds are preferably complex compounds formed between platinum in the oxidation state 0 and vinyl-substituted siloxanes. These types of platinum-vinylsiloxane complex compounds are well known to persons skilled in the art, and their preparation (and application as hydrosilylation catalysts) are described for example, in U.S. Pat. Nos. 3,715,334 and 3,775,452.

The compound 1,3-divinyl-1,1,3,3-tetramethyldisiloxane (“Pt-VTS”) is particularly preferably used as an organic platinum complex compound with platinum in the oxidation state 0. This compound can be obtained as the reaction product of 1,3-divinyl-1,1,3,3-tetramethyldisiloxane and platinum salts or platinum complex compounds such as in particular hexachloroplatinic acid. It should be noted here that these types of compounds are generally not stoichiometrically precisely defined, pure products, but are mostly a mixture of starting compounds, excess vinylsiloxane, solvents and optionally further stabilising complex-producers and additives, the desired product in accordance with the formula and also secondary products, homologues and derivatives thereof produced during synthesis.

The platinum-vinylsiloxane complex compounds can be decomposed, for example, by drying at a temperature of 110 to 200° C. Very finely distributed, elemental platinum is left behind. Residues of silicon and/or silicon compounds arising from the siloxane, or of other organic compounds, will also remain in the final layer and may be detected and measured by appropriate technologies.

The platinum complex compound may also be formulated as a coating composition that consists substantially of this compound, preferably the complex of platinum in the oxidation state 0 and 1,3-divinyl-1,1,3,3-tetramethyldisiloxane. Other components in these types of coating compositions are inert, volatile organic solvents such as aliphatic or aromatic-compounds, olefins, alcohols, ethers, esters, carboxylic acids, sulfoxides, amides, dimethylsulfoxide, dimethylformamide or mixtures of these. In addition, complex-producers that function as ligands stabilising the platinum complex may also be present.

Typically, the coating composition contains 1 to 25 wt. % of platinum (with respect to the total amount, as metallic platinum).

The platinum complex compound or the coating composition containing this can be applied to the surface of the substrate material by conventional coating methods such as single or repeated painting, rolling, spraying or dipping procedures. As a result of this simple mode of working, subsequent aftercoating or the repair of defective layers is also very easy.

Following this, the coated and/or infiltrated substrate material is subjected to thermal treatment at temperatures up to 200° C. The platinum complex compound then decomposes and all the volatile constituents of the solution, as well as decomposition products are removed from the substrate material via the gas phase. This decomposition and removal of volatile fractions may optionally also be performed under vacuum. The thickness achieved at any position in the layer can be affected by the platinum content of the solution. Several layers may be placed on top of each other in order optionally to control the thickness of the layer.

The coatings obtained in this way, of a black modification of platinum, in which the platinum coating is formed from fine dispersoid platinum particles, can subsequently optionally also be subjected to an annealing process for possible further consolidation and stabilisation. Typically this annealing process is performed at temperatures of 800 to 1450° C. and for a period of 1 to 100 hours. In particular thicker layers can be converted into platinum coatings with the conventional typical appearance of platinum, that is metallic grey to very shiny silver-white, by sufficiently prolonged sintering close to the melting point of platinum or by heating to above this melting point.

The surface coatings according to the invention made of black platinum are extremely mechanically stable and adhere firmly and are in particular very resistant to abrasion and flaking. Thus, for example, steel sheets with a thickness of 1 mm that are provided with black platinum coatings according to the invention of 0.05 to 1 μm can be strained up to the point where cracks are formed in the underlying material without damaging the layer.

The surface coatings according to the invention made of platinum in a black modification have surprising, unusual and, for a number of different industrial applications, extremely advantageous properties.

Due to their pronounced mechanical, chemical and thermal resistance, black platinum coatings according to the invention are especially suitable for use as protective layers against mechanical and/or chemical and/or thermal effects.

Examples of these are, for example, claddings on chemical reactors and, in the glass industry, use as functional layers on structural or handling parts in plant or parts of plant which come into contact with molten glass. Here, the protective properties can be used to advantage, due to the high resistance to abrasion and adhesive strength, anti-stick properties and antireflective properties, as shown in the examples given below.

Ceramic components are used for the manual handling of liquid glass melts. A typical tool is the delivery ball for the manual removal of glass from the tank. These ceramic components are broken down under attack by the glass and this leads to defects, streaks, in the glass products.

A zirconium mullite ball for the transfer of glass to moulds was coated with a layer (2 μm) of black platinum according to the invention and tested in comparison with an uncoated ball during the processing of borosilicate glass. In contrast to the uncoated ball, no erosive wear could be observed on the coated ball after 8 hours. The glass products produced had no streaks.

Surprisingly, it has been shown that surface coatings of black platinum according to the invention, possibly due to their fine dispersoid microstructure, have pronounced anti-stick characteristics. For this reason, they are especially suitable for use as non-stick coatings.

This is equally advantageous, for example in the glass industry, for the coating of structural parts in plant or parts of plant that come into contact with molten glass.

High mould temperatures are a prerequisite for the production of large two-dimensional pressed glass sheets for the flow-line-free preparation of glass products. During the shaping of, for example, borosilicate glass in steel moulds, tuyères and compression moulds, however, the glass can “stick” to the metal and the mould has to be taken out of the manufacturing process.

The shaping region of a production mould for processing borosilicate glass was provided with a black platinum layer (0.5 μm) according to the invention and the functionality was tested under production conditions in comparison with an uncoated mould. In contrast to the uncoated mould, the processing temperature could be raised by 200° C. to 680° C., without adhesion of the borosilicate glass to the mould being observed, with the same number of products. The flow-lines occurring when using the uncoated mould were not present when using the coated mould. The results of this trial could be transferred to compression moulds for the processing of crystal glass, with the same positive results.

Furthermore, black platinum coatings according to the invention are especially suitable as antireflective, light and/or heat radiation-absorbing layers.

Again, this is also of advantage, for example, in the glass industry for the coating of structural parts in plant or parts of plant that come into contact with molten glass.

The high reflective capacity of metallic shiny layers can lead to crystallisation, and thus to rejects, during the processing of transparent glasses. The application of black functional layers of platinum according to the invention combines the thermal, mechanical and chemical protective effect of platinum with a change in the coefficient of reflection.

Layers of black platinum according to the invention, with a thickness between 0.1 and 5 μm, were applied to flat samples of zirconium mullite and placed in a muffle furnace at 1450° C. for 24 hours. Irrespective of the thickness of layer applied, the typical black colour was still present on all the samples.

Furthermore, surface coatings of platinum in a black modification according to the invention have pronounced catalytic properties that can be used to advantage, for example, during the afterburning of fuel and exhaust gas residues, for example in internal combustion engines and turbine-driven plant. Thus, for example, surface coatings according to the invention on pistons, cylinder heads, cylinder linings, valves, valve seats and rockers, inlet nozzles, ignition and heater plugs, exhaust gas manifolds and the bladed wheels of exhaust gas turbo-superchargers, etc., prevent the deposition-of combustion residues due to catalytic afterburning. The non-stick properties of the coating also promote this effect.

The same applies to the coating of parts of turbine-driven plant such as the rotors, stators, combustion chambers, turbine blades, etc., wherein the wear-resistance of surface coatings according to the invention also make an advantageous contribution here.

The catalytic properties of the surface coatings of platinum in a black modification according to the invention can also be used to great advantage, for example, in devices for the catalytic recombination of hydrogen and oxygen, for example as a functional layer on recombiners in the containment shells of light water nuclear reactors as is described, for example, in EP 0 959 477 A1. It has been shown that black platinum layers according to the invention are considerably more effective than catalytic platinum layers according to the prior art.

Not least, surface coatings of platinum in a black modification according to the invention can be used in the decorative field, for example for creating jewellery, wherein here it is primarily the black appearance, but also the resistance to abrasion, of the layer, which is important.

Having now generally described the invention, the same may be more readily understood through the following reference to the following examples, which are provided by way of illustration and are not intended to limit the present invention unless specified.

### EXAMPLES

### Example 1

### Preparation of a Complex Compound of Platinum in Oxidation State 0 with 1,3-divinyl-1,1,3,3-tetramethyldisiloxane (“Pt-VTS”)

This compound is prepared in the way described in U.S. Pat. Nos. 3,775,452 and 3,715,334.

20 parts by weight of sodium bicarbonate are added to a mixture of 10 parts by weight of H₂PtCl₆.8H₂O and 20 parts by weight of 1,3-divinyl-1,1,3,3-tetramethyldisiloxane and 50 parts by weight of ethanol. The mixture is heated under reflux, with stirring, for 30 minutes, allowed to stand for 15 hours and then filtered. The readily volatile constituents in the mixture are distilled off under vacuum. The residue is dissolved in benzene, filtered again and the benzene is then distilled off under vacuum. The platinum content of the liquid residue is 18.1 wt. %.

### Example 2

### Coating Moulds for Producing Glass Articles

Function: High-temperature protective layer; avoiding the adherence of glass at high temperatures

Aim: To increase the mould temperature in order to reduce the occurrence of flow-lines in the product

| Coating material: | |
|---|---|
| Medium | Pt-VTS solution, Pt content |
| | 20 wt. % |
| Substrate material: | |
| Material | 1.4057 |
| Cleansing | Acetone |
| Surface | Polished |
| Surface roughness Ri | 1 μm |
| Coating: | |
| Solution | Undiluted |
| Tool used | Spray-gun |
| | 0.3 bar overpressure |
| Application | Spray mist |
| | 1 pass corresponds to 2 g per m² |
| | (0.1 μm thick) |
| Number of layers | 5 layers, |
| | Intermediate drying at room |
| | temperature, 10 min |
| Thickness of layer | 0.5 μm (calculated) |
| Drying | Vacuum drying, cabinet |
| | 70° C./1 hour (rate of heating |
| | 2 K/min) |
| Thermal decomposition | Vacuum drying cabinet |
| | 200° C./5 hours (rate of heating |
| | 2 K/min) |
| Colour of layer | Black |
| Test conditions: | |
| Mould | Heated to 620° C. mould |
| | temperature |
| Type of glass | Borosilicate glass |
| Glass temperature | 1400° C. |
| Temperature at the | 820° C. |
| contact surface | |
| Mould temperature | Without coating |
| | introduction 540° C./removal |
| | 590° C. |
| | With coating |
| | introduction 620° C./removal |
| | 660° C. |
| Cycle time | 2 min |
| Results: | |
| Number of products | 70 items (with coating) |
| | 0 (without coating) |
| Adhesion | No adhesion |
| Flow-lines | No flow-lines in the product |
| Colour of the coating | Black (also after use) |

### Example 3

### Determination of Maximum Mould Temperature for Processing Glass Articles

Function: High-temperature protective layer; avoiding the adherence of glass at high temperatures

Aim: To determine the maximum working temperature; wear trials

| Coating material: | |
|---|---|
| Medium | Pt-VTS solution, Pt content |
| | 20 wt. % |
| Substrate material: | |
| Material | 1.4057 |
| Cleansing | Acetone |
| Surface of sheet 1 | Polished |
| Dimensions of sheet 1 | 400 mm × 100 mm × 10 mm |
| Surface roughness 1 Ri | 1 μm |
| Surface of sheet 2 | Ground |
| Dimensions of sheet 2 | 400 mm × 100 mm × 10 mm |
| Surface roughness 2 Ri | 2 μm |
| Surface of sheet 3 | Sand-blasted |
| Dimensions of sheet 3 | 400 mm × 100 mm × 10 mm |
| Surface roughness 3 Ri | 6 μm |
| Coating: | |
| Solution | Undiluted |
| Tool used | Spray-gun |
| | 0.3 bar overpressure |
| Application | Spray mist |
| | 1 pass corresponds to 2 g per m² |
| | (0.1 μm thick) |
| Number of layers | 5 layers, |
| | intermediate drying at room |
| | temperature, 10 min |
| Thickness of layer | 0.5 μm (calculated) |
| Drying | Vacuum drying cabinet |
| | 70° C./1 hour (rate of heating |
| | 2 K/min) |
| Thermal decomposition | Vacuum drying cabinet |
| | 200° C./5 hours (rate of heating |
| | 2 K/min) |
| Colour of coating | Black |
| Test conditions: | |
| Type of glass | Borosilicate glass |
| Glass temperature | 1400° C. |
| Temperature of test | 820° C. |
| material | |
| Duration of test | Test series 1: 1 hour |
| | Layer as coated |
| | Test series 2: 1 hour |
| | Layer partly damaged |
| Results: | |
| Test series 1 | All 3 sheets exhibited no |
| | adhesion |
| | No flow-lines visible |
| | No wear of layer visible |
| | Effect of roughness on the glass |
| | product is not visible |
| Test series 2 | All 3 sheets exhibited adhesion |
| | in the region of the partial |
| | damage |
| | No adhesion could be detected in |
| | the region of the intact layer |
| | No flow-lines visible |
| | No wear of layer visible |
| | Effect of roughness on the glass |
| | product is not visible |
| Colour of the coating | Black (also after use) |

### Example 4

### Resistance to Fluctuating Temperature (RFT) of the Layer

Function: High-temperature protective layer

Aim: To determine the resistance to fluctuating temperature (RFT) of the layer

| Coating material: | |
|---|---|
| Medium | Pt-VTS solution, Pt content |
| | 20 wt. % |
| Substrate material: | |
| Material | 1.2787 |
| Cleansing | Acetone |
| Surface | As rolled |
| Dimensions of sheet | 200 mm × 100 mm × 1 mm |
| Surface roughness Ri | 1 μm |
| Coating: | |
| Solution | Undiluted |
| Tool used | Spray gun |
| | 0.3 bar overpressure |
| Application | Spray mist |
| | 1 pass corresponds to 2 g per m² |
| | (0.1 μm thick) |
| Number of layers | 5 layers |
| | intermediate drying at room |
| | temperature, 10 min |
| Thickness of layer | 0.5 μm (calculated) |
| Drying | Vacuum drying cabinet |
| | 70° C./1 hour (rate of heating |
| | 2 K/min) |
| Thermal decomposition | Vacuum drying cabinet |
| | 200° C./1 hour (rate of heating |
| | 2 K/min) |
| Colour of coating | Black |
| Test conditions: | |
| Kiln temperature | 1000° C. |
| Cooling | Rapid cooling in water |
| Number of cycles | 10 |
| Number of sheets | 5 |
| Results: | |
| | All the sheets exhibited severe |
| | faults |
| Damage to the layer | No flaking of layer visible |
| Colour of the coating | Black (also after use) |

### Example 5

### Coating Ceramics

Function: High-temperature protective layer; avoidance of ceramic streaks in-glass products due to ceramic handling devices

Aim: To determine the resistance to fluctuating temperature (RFT) of the layer

| Coating material: | |
|---|---|
| Medium | Pt-VTS solution, Pt content |
| | 20 wt. % |
| Substrate material: | |
| Material | Zirconium mullite |
| Cleansing | Strong heating 1200° C./1 h |
| Surface | As supplied |
| Dimensions of ceramic 1 | Ball Ø 110 mm |
| Dimensions of ceramic 2 | Ball Ø 80 mm |
| Coating: | |
| Solution | Undiluted |
| Tool used | Brush |
| Application | Painted on |
| Number of layers | 5 layers |
| | intermediate drying at room |
| | temperature, 10 min |
| Thickness of layer | 2 μm (calculated) |
| Drying | Vacuum drying cabinet |
| | 70° C./1 hour (rate of heating |
| | 2 K/min) |
| Thermal decomposition | Vacuum drying cabinet |
| | 200° C./1 hour (rate of heating |
| | 2 K/min) |
| Colour of coating | Black |
| Test conditions: | |
| Type of glass 1 | Borosilicate glass |
| Glass temperature 1 | 1500° C. |
| Duration of test 1 | 8 hours |
| Type of glass 2 | Crystal glass |
| Glass temperature 2 | 1200° C. |
| Duration of test 2 | 8 hours |
| Results: | |
| Type of glass 1 | No white streaks due to ceramic |
| | in the product |
| | Ceramic not attacked by the |
| | glass |
| | Geometry of ceramic retained |
| Colour of coating | Black (also after use) |
| Type of glass 2 | No white streaks due to ceramic |
| | in the product |
| | Ceramic not attacked by the |
| | glass |
| | Geometry of ceramic retained |
| Colour of coating | Black (also after use) |

### Example 6

### Changing the Coefficient of Reflection of Platinum Coatings

Function: High-temperature protective layer

Aim: Avoidance of crystallisation effects in industrial glass due to changing the surface colour of platinum

| Coating material: | |
|---|---|
| Medium | Pt-VTS solution, Pt content |
| | 20 wt. % |
| Substrate material: | |
| Material 1 | Zirconium mullite |
| Material 2 | Chamotte fireclay |
| Cleansing | Strong heating 1200° C./1 h |
| Surface | As supplied |
| Dimensions of ceramic | Ø 20 mm, 1 150 mm |
| Coating: | |
| Solution | Undiluted |
| Tool used | Brush |
| Application | Painted on |
| Number of layers | 5 layers |
| | intermediate drying at room |
| | temperature, 10 min |
| Thickness of layer | 2 μm (calculated) |
| Drying | Vacuum drying cabinet |
| | 70° C./1 hour (rate of heating |
| | 2 K/min) |
| Thermal decomposition | Vacuum drying cabinet |
| | 200° C./1 hour (rate of heating |
| | 2 K/min) |
| Colour of coating | Black |
| Test conditions: | |
| Type of glass | Borosilicate glass |
| Glass temperature | 1300° C. |
| Duration of test | 24 hours |
| Results: | |
| Material 1 | Ceramic not attacked by the |
| | glass |
| | Geometry of ceramic retained |
| Colour of coating | Black (also after use) |
| Material 2 | Ceramic not attacked by the |
| | glass |
| | Geometry of ceramic retained |
| Colour of coating | Black (also after use) |

### Example 7

### Resistance to Abrasion and Adhesive Strength

Function: To test the adhesive strength of the coating on sheets using the Erichsen test

Aim: To determine the adhesive strength of the layers by dry friction; determination of the adhesive strength during forming of sheets

Coating material:

| | |
|---|---|
| Medium | Pt-VTS solution, Pt content |
| | 120 wt.% |
| Substrate material: | |
| Material 1 | 1.4301 |
| Cleansing | Acetone |
| Surface | As rolled |
| Dimensions of sheet | 200 mm × 100 mm × 1 mm |
| Surface roughness Ri | 1 μm |
| Coating: | |
| Solution | Undiluted |
| Tool used 1 | Brush |
| Application 1 | Painted on |
| Tool used 2 | Spray-gun |
| | 0.3 bar overpressure |
| Application 2 | Spray mist |
| | 1 pass corresponds to 2 g per m² |
| | (0.1 μm thick) |
| Number of layers | 1-5layers |
| | temperature, 10 min |
| Thickness of layer | 0.1-0.5 μm (calculated) |
| Drying | Vacuum drying cabinet |
| | 70° C ./ 1 hour (rate of heating |
| | 2 K/min) |
| Thermal decomposition | Vacuum drying cabinet |
| | 200° C. / 5 hours (rate of heating |
| | 2 K/min) |
| Number of layers | 5 layers |
| | intermediate drying at room |
| | temperature, 10 min |
| Thickness of layer | 2 μm (calculated) |
| Drying | Vacuum drying cabinet |
| | 70° C. / 1 hour (rate of heating |
| | 2 K/min) |
| Thermal decomposition | Vacuum drying cabinet |
| | 200° C. / 1 hour (rate of heating |
| | 2 K/min) |
| Colour of coating | Black |
| Test conditions: | |
| Test series 1 | Ball Ø 16 mm / contact force F = |
| | 2.1 Mp formed sheet |
| | Dry friction between layer and |
| | steel ball; no streaks |
| | 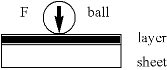 |
| Test series 2 | Ball Ø 16 mm / contact force F = |
| | 2.1 Mp formed sheet |
| | Dry friction between sheet and |
| | steel ball; no streaks |
| 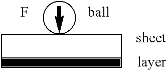 | |
| Duration of test | Forming up to failure point of |
| | basic material |
| Results: | |
| Test series 1 | Partial abrasion of layer in |
| | region of material flow |
| | No visible effects of abrasion |
| | on thickness of layer or |
| | application procedure |
| Colour of coating | Black (also after use) |
| Test series 2 | No detectable loosening of layer |
| | No visible effects of abrasion |
| | on thickness of layer or |
| | application procedure |
| Colour of coating | Black (also after use) |

1. A surface coating comprising a platinum coating that is formed from a black modification of platinum, said platinum coating comprising platinum and silicon and/or a silicon compound.

2. A surface coating according to claim 1, wherein the platinum coating is formed from fine dispersoid platinum particles.

3. A surface coating according to claims 1 or 2, wherein the platinum coating has a thickness of 1 nm to 10 μm.

4. A surface coating according to claims 1, 2 or 3, wherein the concentration per unit area of platinum is 0.01 to 100 g/m².

5. A surface coating of platinum in a black modification obtainable by:
(a1) applying an organic platinum complex compound with platinum in the oxidation state 0 that decomposes thermally at temperatures below 200° C. with the formation of fine dispersoid platinum particles to the surface of a substrate; or
(a2) applying a coating composition that consists substantially of a complex of platinum in the oxidation state 0 with 1,3-divinyl-1,1,3,3-tetramethyldisiloxane to the surface of a substrate; and
(b) thermally decomposing the platinum complex compound.

6. A surface coating according to claim 5, obtainable by applying a coating composition that consists substantially of a complex of platinum in the oxidation state 0 with 1,3-divinyl-1,1,3,3-tetramethyldisiloxane.

7. A surface coating according to claim 5 or 6, obtainable by applying a coating composition that contains 1 to 25 wt. % of platinum.

8. A process for preparing a surface coating of platinum in a black modification, comprising
(a1) applying an organic platinum complex compound with platinum in the oxidation state 0 which decomposes thermally at temperatures below 200° C. to the surface of a substrate compound; or
(a2) applying a coating composition that consists substantially of a complex of platinum in the oxidation state 0 with 1,3-divinyl-1,1,3,3-tetramethyldisiloxane to the surface of a substrate;
and subsequently thermally decomposing said platinum complex.

9. A process according to claim 8, wherein the coating composition consists substantially of a complex of platinum in the oxidation state 0 with 1,3-divinyl-1,1,3,3-tetramethyldisiloxane.

10. A process according to claim 8 or 9, wherein the coating composition contains 1 to 25 wt. % of platinum.

11. A coating composition for use in a process in accordance with claims 8 to 10 for producing a surface coating of platinum in a black modification, consisting substantially of an organic platinum complex compound with platinum in the oxidation state 0 which decomposes thermally at temperatures below 200° C. with the formation of fine dispersoid platinum particles.

12. A coating composition according to claim 11, wherein said coating composition consists substantially of a complex of platinum in the oxidation state 0 with 1,3-divinyl-1,1,3,3-tietramethyldisiloxane.

13. A coating composition according to claim 11 or 12, wherein platinum is 1 to 25 wt. % of said coating composition.

14. The use of surface coatings of platinum in a black modification in accordance with claims 1 to 7 as a protective layer against mechanical and/or chemical and/or thermal effects.

15. The use of surface coatings of platinum in a black modification in accordance with claims 1 to 7 as an antiadhesion coating.

16. The use of surface coatings of platinum in a black modification in accordance with claims 1 to 7 as an antireflective, light and/or heat radiation-absorbing layer.

17. The use according to at least one of claims 14 to 16 as a functional layer on structural parts in plants or parts of plants which come into contact with molten glass.

18. The use of surface coatings of platinum in a black modification in accordance with claims 1 to 7 as a catalytically active layer.

19. The use according to claim 18 as a layer to prevent the deposition of combustion residues in internal combustion engines and turbine-driven plant.

20. The use according to claim 18 in devices for the catalytic recombination of hydrogen and oxygen.

21. The use of surface coatings of platinum in a black modification in accordance with claims 1 to 7 as a decorative layer.
